(19) United States
(12) Patent Application Publication
(10) Pub. No.: US 2021/0172652 A1
(43) Pub. Date: Jun. 10, 2021

(54) TRANSVERSE FUEL FIRED FORCED AIR SPACE HEATER

(71) Applicant: UNITED STATES STOVE COMPANY, South Pittsburg, TN (US)

(72) Inventors: Brandon Lane Barry, Sewanee, TN (US); Anderson Smith, York, PA (US); Joe Alessi, Valparaiso, IN (US)

(21) Appl. No.: 17/105,223

(22) Filed: Nov. 25, 2020

Related U.S. Application Data
(60) Provisional application No. 62/940,148, filed on Nov. 25, 2019.

(51) Int. Cl. F24H 3/04

(52) U.S. Cl. CPC F24H 3/0488

(57) ABSTRACT

A fuel (e.g., fluid fuel such as propane or natural gas) fired portable forced air heater has a non-linear air flow and an enclosed combustion chamber. Air intake is longitudinal, and heated air output is axial (i.e., perpendicular to the longitudinal axis). Aspects of the invention eliminate an exposed open flame in forced air fluid fuel fired space heaters. Feet and handles of the heater housing are shaped so as to provide appropriate safety clearances for the heater, and the air flow path of the heater keeps a housing of the heater near room temperature.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims priority to and hereby incorporates by reference in its entirety U.S. Provisional patent Application No. 62/940,148 entitled “TRANSVERSE FUEL FIRED FORCED AIR SPACE HEATER” filed on Nov. 25, 2019.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to space heaters. More particularly, this invention pertains to fluid fuel combustion appliances as forced air space heaters.

A fluid fuel (e.g., propane or natural gas) based forced air heater or space heater typically uses a fan (e.g., blower) for pushing ambient air through and around a combustion chamber. As the air flows around and through the combustion chamber, fuel (e.g., propane) is introduced into the air stream, and the air/fuel mixture is ignited by an ignition source. The air stream (i.e., exhaust gases and blower air) is exhausted into the space to be heated. Most of these propane space heaters are tube style heaters such that the heated air is exhausted through the longitudinal end of the tube opposite the intake end of the combustion chamber directly into the area to be heated. While forced air heaters are a practical source of temporary heating in outdoor or unfinished construction heating spaces, the combustion chamber of a typical portable forced air heater is open to heated space. This open-ended combustion chamber exposes an open flame to the area being heated which is a fire hazard, particularly in construction and shop environments where combustible materials are necessarily present.

### BRIEF SUMMARY OF THE INVENTION

Aspects of the invention provide a fuel (e.g., fluid fuel such as propane or natural gas) fired portable forced air heater having non-linear air flow and an enclosed combustion chamber. Air intake is longitudinal, and heated air output is axial (i.e., perpendicular to the longitudinal axis). In this way, aspects of the invention eliminate an exposed open flame in forced air fluid fuel fired space heaters. Additionally, features of the portable heater such as feet and handles are shaped so as to provide appropriate safety clearances for the heater, and the air flow path of the heater keeps a housing of the heater near room temperature.

In one embodiment, a fuel fired forced air heater includes a housing, a combustion chamber, and a blower. The combustion chamber and the blower are within the housing. The housing extends longitudinally. The housing includes a first end including an air intake, and a first side including a heat discharge. The combustion chamber is configured to receive fuel and burn the fuel therein. The blower is configured to receive air from the air intake, pass the air across an outside surface of the combustion chamber, and exhaust the air from the heater via the heat discharge.

### BRIEF DESCRIPTION OF THE SEVERAL VIEWS OF THE DRAWINGS

FIG. 1 is an isometric view of a fuel fired forced air heater according to one embodiment of the invention.

FIG. 2 is a top perspective view of the fuel fired forced air heater of FIG. 1.

FIG. 3 is an end perspective view of the fuel fired forced air heater of FIG. 1.

FIG. 4 is a side perspective view of the fuel fired forced air heater of FIG. 1.

FIG. 5 is an end perspective view of the intake end of the fuel fired forced air heater of FIG. 1.

FIG. 6 is a perspective cutaway view of the heater of FIG. 4 from a first end of the heater along the line B.

FIG. 7 is a perspective cutaway view of the heater of FIG. 4 from a second end of the heater along the line C.

FIG. 8 is a perspective cutaway view of the heater of FIG. 4 from a first side of the heater along the line A.

FIG. 9 is a side perspective view of a second end of the combustion chamber of the heater of FIG. 4.

Reference will now be made in detail to optional embodiments of the invention, examples of which are illustrated in accompanying drawings. Whenever possible, the same reference numbers are used in the drawing and in the description referring to the same or like parts.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component. As used herein, the upright orientation of the heater is sitting on a level surface with the bottom down and top up such that the heater is ready for operation or may be in operation.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without operator input or prompting, whether these features, elements and/or states are included or are to be performed in any particular embodiment.

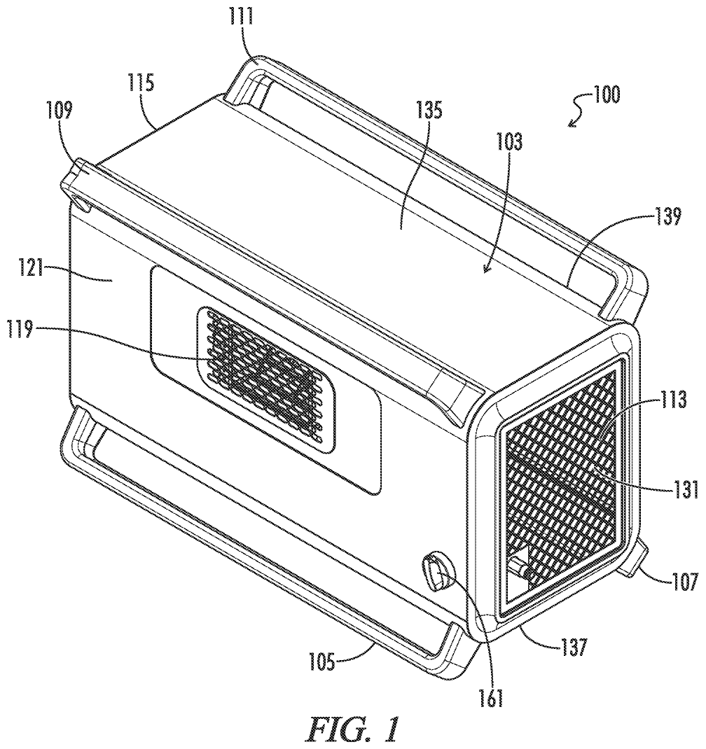

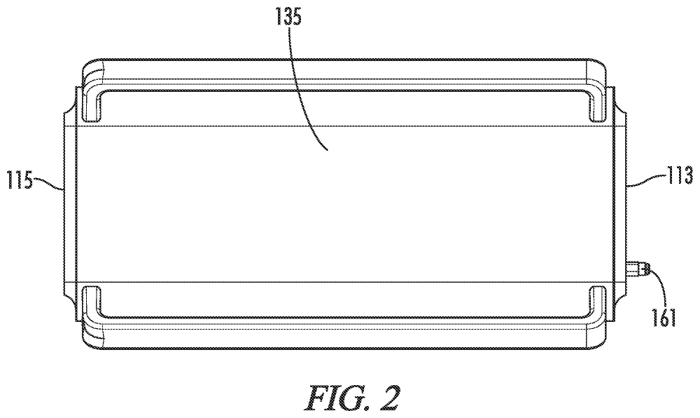

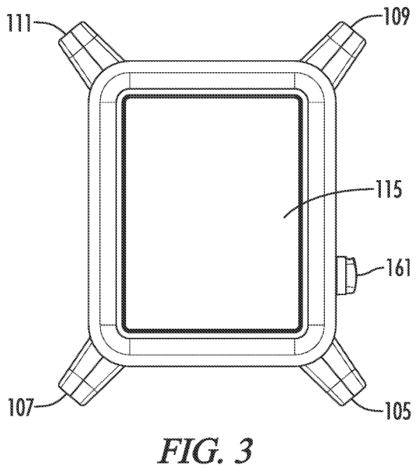

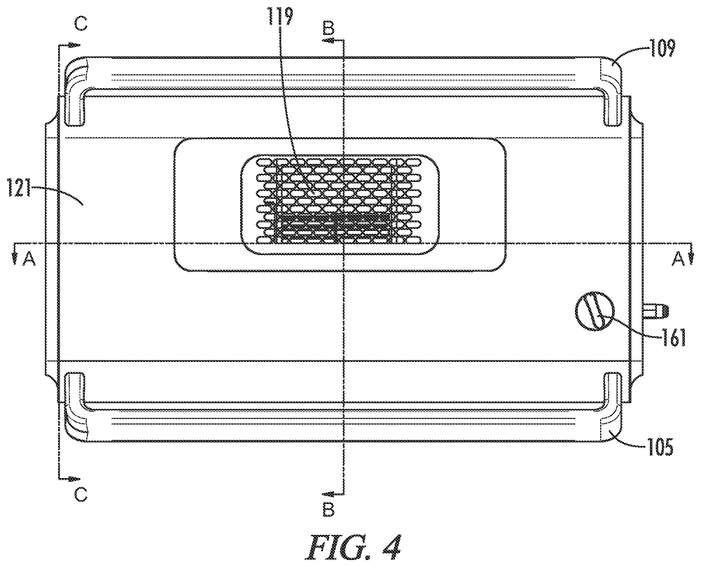

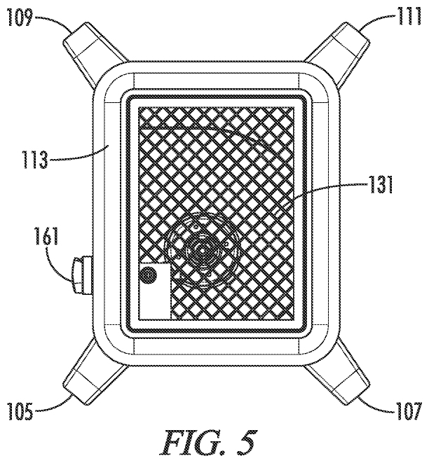

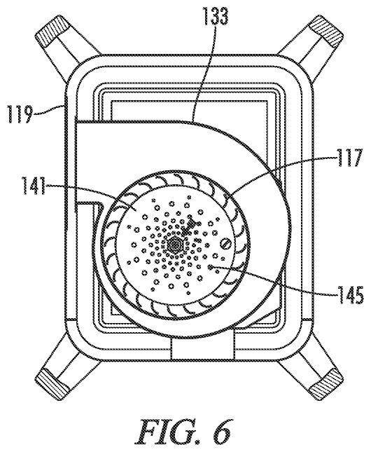

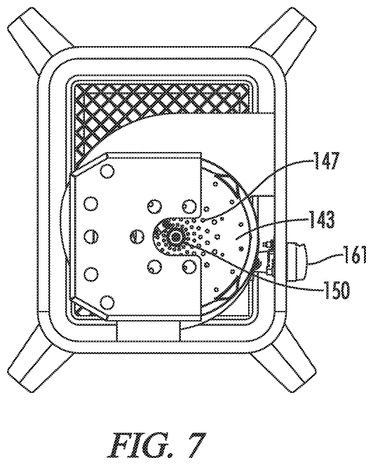

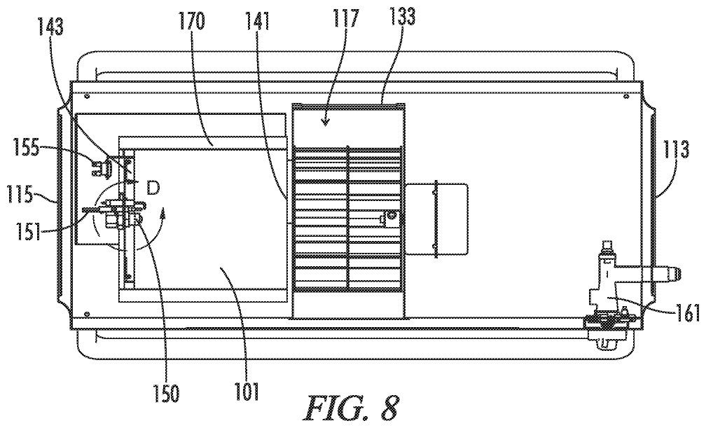

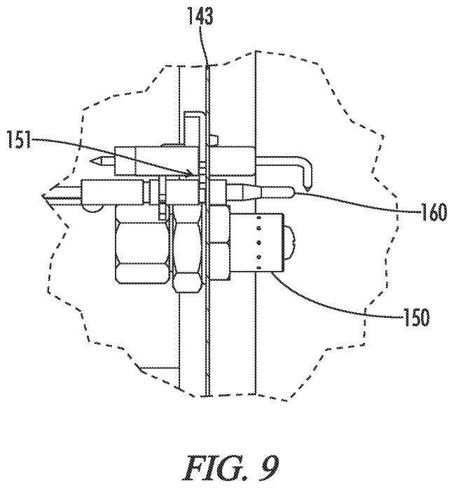

Referring to FIGS. 1-9, a forced air heater 100 includes an enclosed combustion burner 101, a housing 103, and a series of feet 105, 107 or handles 109, 111 about the housing 103. The housing 103 is generally elongated along a longitudinal axis. The enclosed combustion chamber 101 eliminates exposure of the combustion flame to the outside environment (i.e., space to be heated by the heater 100). The combustion chamber 101 including an enclosed burner is at the opposite end 115 of the heater from the air intake 113 and separate from the room air fan 117 and air outlet 119 of the heater 100. Containing combustion remotely from the room airflow requires construction of space around the combustion chamber 101 and heater housing 103 to remove heat from surrounding, potentially combustible, materials that might come in contact with the heating appliance 100 when operating.

The heater 100 includes a series of feet 105, 107 and handles 109, 111 extending from the housing 103 of the heater 100 to create a zone of space around the housing 103 of the appliance 100 to remove and prevent contact of the heater housing 103 with potentially combustible materials. This series of feet 105, 107 and handles 109, 111 utilizes specific geometry to create a safe zone of combustion (i.e., an area free from combustion about the housing 103) and to orient the exhaust or room air output 119 upward from a plane (i.e., a plane defined by a surface upon which the heater 100 is sitting in an upright position).

The fuel fired portable forced air heating appliance 100 utilizes crosswise or non-axial blower system to exhaust heated air through the non-axial front face 121 of the appliance 100. The fuel fired portable forced air heating appliance 100 utilizing feet 105, 107 and handles 109, 111 to lift the base of the appliance housing 101 away from a surface that the appliance 100 rests on to protect the surface from exposure to heat. Similarly, feet 105, 107 and handles 109, 111 protect the outside environment from foreign objects resting on a top or sides of the appliance 100 and exposing foreign objects to heat from the appliance 100.

In one embodiment, a fuel fired portable forced air heating appliance 100 includes a primary combustion chamber 101 offset from axial airflow where ambient air is inducted through the axial end 113 of the appliance 100 to the combustion chamber 101 and then exhausted through a cross axial opening 119 in the front face 121 of the appliance 100. In one embodiment, a foot 105, 107 and handle set 109, 111 is oriented either longitudinally (along the axis) or cross-longitudinally (perpendicular to the axis) to create clearances for the housing 103 of the heating appliance 100 to combustibles proportional to the temperatures generated by the enclosed combustion. In one embodiment, combustion is fully enclosed within the appliance 100 preventing open flame from combustion from being exposed to the outside environment. In one embodiment, airflow is driven by a blower system 117 mounted perpendicularly to the main axis of the heating appliance 100. In one embodiment, airflow is non-linear where ambient air enters the appliance on one axis (e.g., the longitudinal axis) but exhausts on an axis perpendicular to air input axis.

In one embodiment, the fuel fired forced air heater 100 includes the housing 103, the combustion chamber 101, and the blower 117. The housing 103 extends longitudinally, and includes a first end 113, and a first side 121. First end 113 includes an air intake 131. In one embodiment, the air intake 131 is a grate (e.g., screen or grill). The first side 121 includes the heat discharge or air outlet 119. In one embodiment, the housing 103 further includes a top 135, a bottom 137 a second side 139 opposite the first side 121, and the second end 115 opposite the first end 113. In one embodiment, the top 135 bottom 137, second end 115, and second side 139 are substantially airtight such that substantially all air entering the housing 103 enters through the air intake 131 of the first end 113 of the housing, and all air exiting the housing 103 exits through the heat discharge 119 in the first side 121 of the housing 103.

The blower 117 is enclosed within the housing 103. The blower 117 is configured to receive air from the air intake 131, passed the air across an outside surface of the combustion chamber 101, and exhaust the air from the heater 100 via the heat discharge 119. In one embodiment, the blower 117 is further configured to draw the air from the air intake 131 across an outside body 133 of the blower 117 before exhausting the air from the heater 100 via the heat discharge 119. In one embodiment, the blower 117 is between the combustion chamber 101 and the first end 113 of the housing 103. In one embodiment, the combustion chamber 101 is between the blower 117 and the second end 115 of the housing 103. In one embodiment, the blower 117 is a centrifugal squirrel cage blower or fan.

The combustion chamber 101 is enclosed within the housing 103. The combustion chamber 101 is configured to receive fuel and burn the fuel therein. In one embodiment, the combustion chamber 101 includes a first end 141, and a second end 143 longitudinally opposite the first end 141 of the combustion chamber 101. The first end 141 of the combustion chamber 101 includes a plurality of holes 145 therethrough. The second end 143 of the combustion chamber 101 also includes a plurality of holes 147 therethrough. The first end 141 of the combustion chamber when one is closer to the first end 113 of the housing 103 than the second end 143 of the combustion chamber 101. The plurality of holes 147 through the second end 143 of the combustion chamber 101 form and air intake for the combustion chamber 101, and the plurality of holes 145 through the first end 141 of the combustion chamber 101 form an outlet for the combustion chamber 101. In one embodiment, the first end 141 of the combustion chamber 101 is sealed to an air intake of the blower 117. In one embodiment, the heater 100 further includes a fuel orifice 150 located in the second end 143 of the combustion chamber 101. In one embodiment, the heater 100 further includes an ignition source 151 located in the second end 143 of the combustion chamber 101 adjacent the fuel orifice 150. In one embodiment, the ignition source 151 is a pilot. In one embodiment, the ignition source 151 is a pilot light and a spark ignition system. In one embodiment, the pilot light has a thermocouple 160 configured to shut off fuel to the pilot light when a temperature of the thermocouple falls below a predetermined limit. In one embodiment, the heater 100 further includes a thermal limit switch 155 at the second end 143 of the combustion chamber 101. The thermal limit switch 155 is configured to shut off fuel to the orifice 150 when the temperature at the second end 143 of the combustion chamber 101 exceeds a predetermined limit.

In one embodiment, the heater 100 further includes an adjustable fuel regulator 161 configured to provide a user to determined fuel flow rate to the fuel orifice 150 in the combustion chamber 101 of the heater 100.

In one embodiment, in use the first end 141 of the combustion chamber 101 is sealed to the intake of the blower 117 such that the air enters the air intake 131 in the first end 113 of the housing 103, passes across an outside body 133 of the blower 117, then across an outside surface 170 of the combustion chamber 101, then through the plurality of holes 147 in the second end 143 of the combustion chamber 101, then through the plurality of holes 145 in the first end 141 of the combustion chamber 101 into the intake of the blower 117, and then through the blower 117 and out of the heater 100 via the heat discharge 119 in the first side 121 of the housing 103 of the heater 100. This air flow path keeps the housing 103 at about room temperature while also cooling the outside surface 170 of the combustion chamber 101 and outside surface 133 of the blower 117.

In one of embodiment, the heater 100 further includes a first foot 105 extending downward from the first side 121 of the housing 103 and outwardly from the bottom 137 of the housing 103 to set the housing 103 off of a surface supporting the heater 100. A second foot 107 extends downward from the second side 139 of the housing 103 and outwardly from the bottom 137 of the housing 103 to set the housing 100 off of the surface supporting the heater 100. The first foot 105 and the second foot 107 each extend longitudinally along the housing 103 of the heater 100. In one embodiment, the first foot 105 is longer than the second foot 107 such that the first side 121 of the housing 103 of the heater 100 and the heat discharge 119 are slightly angled up from the surface. In one embodiment, the heater 100 further includes the first handle 109 extending upwardly from the top 135 of the housing 103 and outwardly from the first side 121 of the housing 103. The heater 100 further includes the second handle 111 extending upwardly from the top 135 of the housing 100 and outwardly from the second side 139 of the housing 100. The first handle 109 and second panel 111 each extend longitudinally along the housing 103. The first foot 105, second foot 107, first handle 109, and second handle 111 cooperate to space the first side 121, second side 139, top 135, and bottom 137 of the housing 103 of the heater 100 a predetermined distance from any flat surfaces adjacent the heater 100.

As used herein, liquid fuel or fluid fuel may be liquid or gas (e.g., natural gas, propane, or camp gas in any liquid or gaseous state).

In one embodiment, the combustion chamber forms an air to air heat exchanger. In one embodiment, the combustion chamber receives combustion air from the blower motor and exhausts the combustion air at a point other than the heat discharge of the housing. In one embodiment, the combustion chamber receives combustion air from the air intake and exhausts combustion air via the heat discharge of the housing via a venturi.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful TRANSVERSE FUEL FIRED FORCED AIR SPACE HEATER it is not intended that such references be construed as limitations upon the scope of this invention except as set forth in the following

What is claimed is:

1. A fuel fired forced air heater comprising:
a housing extending longitudinally, said housing comprising:
a first end comprising an air intake; and
a first side comprising a heat discharge;
a combustion chamber within the housing, said combustion chamber configured to receive fuel and burn the fuel therein; and
a blower configured to receive air from the air intake, pass the air across an outside surface of the combustion chamber, and exhaust the air from the heater via the heat discharge.

2. The fuel fired forced air heater of claim 1, wherein the blower is further configured to draw the air from the air intake across an outside body of the blower before exhausting the air from the heater via the heat discharge.

3. The fuel fired forced air heater of claim 1, wherein the housing further comprises:
a top;
a bottom; and
a second side opposite the first side;
a second end opposite the first end;
wherein the top, bottom, second end, and second side are substantially airtight such that substantially all air entering the housing enters through the air intake of the first end of the housing.

4. The fuel fired forced air heater of claim 1, wherein the air intake comprises a grate, grill, or screen enclosing the first end of the housing.

5. The fuel fired forced air heater of claim 1, wherein:
the housing comprises a second end longitudinally opposite the first end;
the blower is between the combustion chamber and the first end; and
the combustion chamber is between the blower and the second end.

6. The fuel fired forced air heater of claim 1, wherein:
the combustion chamber comprises a first end;
the combustion chamber comprises a second end longitudinally opposite the first end of the combustion chamber;
the first end of the combustion chamber comprises a plurality of holes therethrough;
the second end of the combustion chamber comprises a plurality of holes therethrough;
the first end of the combustion chamber is closer to the first end of the housing than the second end of the combustion chamber;
the plurality of holes through the second end of the combustion chamber form an air intake for the combustion chamber; and
the plurality of holes through the first end of the combustion chamber form an outlet for the combustion chamber.

7. The fuel fired forced air heater of claim 1, wherein:
the combustion chamber comprises a first end;
the combustion chamber comprises a second end longitudinally opposite the first end of the combustion chamber;
the first end of the combustion chamber comprises a plurality of holes therethrough;
the second end of the combustion chamber comprises a plurality of holes therethrough;
the first end of the combustion chamber is closer to the first end of the housing than the second end of the combustion chamber; and
the first end of the combustion chamber is sealed to an intake of the blower.

8. The fuel fired forced air heater of claim 1, wherein:
the combustion chamber comprises a first end;
the combustion chamber comprises a second end longitudinally opposite the first end of the combustion chamber;
the first end of the combustion chamber comprises a plurality of holes therethrough;
the second end of the combustion chamber comprises a plurality of holes therethrough;
the first end of the combustion chamber is closer to the first end of the housing than the second end of the combustion chamber; and
the heater further comprises a fuel orifice located in the second end of the combustion chamber.

9. The fuel fired forced air heater of claim 1, wherein:
the combustion chamber comprises a first end;
the combustion chamber comprises a second end longitudinally opposite the first end of the combustion chamber;
the first end of the combustion chamber comprises a plurality of holes therethrough;
the second end of the combustion chamber comprises a plurality of holes therethrough;
the first end of the combustion chamber is closer to the first end of the housing than the second end of the combustion chamber;
the heater further comprises a fuel orifice located in the second end of the combustion chamber; and
the heater further comprises an ignition source located in the second end of the combustion chamber adjacent the fuel orifice.

10. The fuel fired forced air heater of claim 1, wherein:
the combustion chamber comprises a first end;
the combustion chamber comprises a second end longitudinally opposite the first end of the combustion chamber;
the first end of the combustion chamber comprises a plurality of holes therethrough;
the second end of the combustion chamber comprises a plurality of holes therethrough;
the first end of the combustion chamber is closer to the first end of the housing than the second end of the combustion chamber;
the heater further comprises a fuel orifice located in the second end of the combustion chamber; and
the heater further comprises an ignition source located in the second end of the combustion chamber adjacent the fuel orifice, wherein the ignition source is a pilot light.

11. The fuel fired forced air heater of claim 1, wherein:
the combustion chamber comprises a first end;
the combustion chamber comprises a second end longitudinally opposite the first end of the combustion chamber;
the first end of the combustion chamber comprises a plurality of holes therethrough;
the second end of the combustion chamber comprises a plurality of holes therethrough;
the first end of the combustion chamber is closer to the first end of the housing than the second end of the combustion chamber;
the heater further comprises a fuel orifice located in the second end of the combustion chamber; and
the heater further comprises an ignition source located in the second end of the combustion chamber adjacent the fuel orifice, wherein the ignition source comprises a pilot light and a spark ignition system.

12. The fuel fired forced air heater of claim 1, wherein:
the combustion chamber comprises a first end;
the combustion chamber comprises a second end longitudinally opposite the first end of the combustion chamber;
the first end of the combustion chamber comprises a plurality of holes therethrough;
the second end of the combustion chamber comprises a plurality of holes therethrough;
the first end of the combustion chamber is closer to the first end of the housing than the second end of the combustion chamber;
the heater further comprises a fuel orifice located in the second end of the combustion chamber; and
the heater further comprises a thermal limit switch at the second end of the combustion chamber, said thermal limit switch configured to shut off fuel to the fuel orifice when the temperature at the second end of the combustion chamber exceeds a predetermined limit.

13. The fuel fired forced air heater of claim 1, wherein:
the combustion chamber comprises a first end;
the combustion chamber comprises a second end longitudinally opposite the first end of the combustion chamber;
the first end of the combustion chamber comprises a plurality of holes therethrough;
the second end of the combustion chamber comprises a plurality of holes therethrough;
the first end of the combustion chamber is closer to the first end of the housing than the second end of the combustion chamber;
the heater further comprises a fuel orifice located in the second end of the combustion chamber; and
the heater further comprises an ignition source located in the second end of the combustion chamber adjacent the fuel orifice, wherein the ignition source comprises a pilot light having a thermocouple configured to shut off fuel to the pilot light when a temperature of the thermocouple falls below a predetermined limit.

14. The fuel fired forced air heater of claim 1, wherein the blower is a centrifugal blower, and the centrifugal blower is a squirrel cage blower.

15. The fuel fired forced air heater of claim 1, wherein the fuel is a fluid fuel.

16. The fuel fired forced air heater of claim 1, further comprising an adjustable fuel regulator configured to provide a user determined fuel flow rate to a fuel orifice in the combustion chamber of the heater.

17. The fuel fired forced air heater of claim 1, wherein:
the combustion chamber comprises a first end;
the combustion chamber comprises a second end longitudinally opposite the first end of the combustion chamber;
the first end of the combustion chamber comprises a plurality of holes therethrough;
the second end of the combustion chamber comprises a plurality of holes therethrough;
the first end of the combustion chamber is closer to the first end of the housing than the second end of the combustion chamber;
the plurality of holes through the second end of the combustion chamber form an air intake for the combustion chamber; and
the plurality of holes through the first end of the combustion chamber form an outlet for the combustion chamber; and
the first end of the combustion chamber is sealed to an intake of the blower such that the air enters the air intake in the first end of the housing, passes across an outside body of the blower, then across an outside surface of the combustion chamber, then through a plurality of holes through a second end of the combustion chamber, then through a plurality of holes through a first end of the combustion chamber into an intake of the blower, and then through the blower and out of the heater via the heat discharge.

18. The fuel fired forced air heater of claim 1, wherein:
the heater further comprises a first foot extending downward from the first side of the housing and outwardly from a bottom of the housing to set the housing off of a surface supporting the heater;
the housing has a second side opposite the first side;
the heater further comprises a second foot extending downward from the second side of the housing and outwardly from the bottom of the housing to set the housing off of the surface supporting the heater;
the first foot is longer than the second foot; and
the first foot and the second foot each extend longitudinally along the housing of the heater.

19. The fuel fired forced air heater of claim 1, wherein:
the heater further comprises a first handle extending upwardly from a top of the housing and outwardly from the first side of the housing;
the heater further comprises a second handle extending upwardly from a top of the housing and outwardly from a second side of the housing, wherein the second side of the housing is opposite the first side of the housing; and
the first handle and the second handle each extend longitudinally along the housing.

20. The fuel fired forced air heater of claim 1, wherein:
the heater further comprises a first foot extending downward from the first side of the housing and outwardly from a bottom of the housing to set the housing off of a surface supporting the heater;
the housing has a second side opposite the first side;
the heater further comprises a second foot extending downward from the second side of the housing and outwardly from the bottom of the housing to set the housing off of a surface supporting the heater;
the first foot is longer than the second foot;
the heater further comprises a first handle extending upwardly from a top of the housing and outwardly from the first side of the housing;
the heater further comprises a second handle extending upwardly from a top of the housing and outwardly from a second side of the housing, wherein the second side of the housing is opposite the first side of the housing;
the first handle and the second handle each extend longitudinally along the housing; and
the first foot, second foot, first handle, and second handle cooperate to space the first side, second side, top, and bottom of the housing of the heater a predetermined distance from flat surfaces adjacent the heater.
